(19) United States
(12) Patent Application Publication
(10) Pub. No.: US 2024/0301565 A1
(43) Pub. Date: Sep. 12, 2024

(54) ELECTROLYZER SYSTEM INCLUDING THERMAL CONTROL COMPONENTS AND METHOD OF OPERATING SAME

(71) Applicant: BLOOM ENERGY CORPORATION, San Jose, CA (US)

(72) Inventors: Jesse DOTY, Santa Maria, CA (US); David EDMONSTON, Soquel, CA (US); Alejandro Carlos LAVERNIA, San Jose, CA (US); Mark STANTON, Santa Clara, CA (US); David WEINGAERTNER, Sunnyvale, CA (US); Shannon BELL, Chula Vista, CA (US)

(21) Appl. No.: 18/597,298

(22) Filed: Mar. 6, 2024

Related U.S. Application Data
(60) Provisional application No. 63/450,730, filed on Mar. 8, 2023.

(51) Int. Cl. C25B 1/042; C25B 9/73; C25B 15/021; C25B 15/08

(52) U.S. Cl. CPC C25B 1/042; C25B 9/73; C25B 15/021; C25B 15/083

(57) ABSTRACT

An electrolyzer system includes electrolyzer cell columns each containing at least one stack of electrolyzer cells that are configured to receive a steam inlet stream and an air inlet stream, and to generate a hydrogen exhaust stream and an oxygen exhaust stream, an air recuperator heat exchanger surrounded by the electrolyzer cell columns and configured to heat the air inlet stream using the oxygen exhaust stream, a steam recuperator heat exchanger surrounded by the electrolyzer cell columns and configured to heat the steam inlet stream using the hydrogen exhaust stream, an outer column heater located radially outward of the electrolyzer cell columns and configured to radiate heat toward radially outward surfaces of the electrolyzer cell columns, and an inner column heater located radially inward of the electrolyzer cell columns, surrounding the air recuperator heat exchanger and the steam recuperator heat exchanger, and configured to radiate heat toward radially inward surfaces of the electrolyzer cell columns.

### FIELD

The present invention is directed to electrolyzer systems including thermal control components for providing improved solid oxide electrolyzer cell (SOEC) operating temperature control and methods of operating the same.

### BACKGROUND

In a solid oxide electrolyzer cell (SOEC), a positive potential is applied to the air side of the cell and oxygen ions are transported from the fuel (e.g., steam) side to the air side. Since the cathode and anode are reversed between a solid oxide fuel cell (SOFC) and a SOEC (i.e. SOFC cathode is SOEC anode, and SOFC anode is SOEC cathode), going forward, the SOFC cathode (SOEC anode) will be referred to as the air electrode, and the SOFC anode (SOEC cathode) will be referred to as the fuel electrode. During SOEC operation, water (e.g., steam) in the fuel stream is reduced (H₂O+2e→O²⁻+H₂) to form H₂ gas and O²⁻ions, the O²⁻ions are transported through the solid electrolyte, and then oxidized (e.g., by an air inlet stream) on the air side (O²⁻to O₂) to produce molecular oxygen (e.g., oxygen enriched air).

### SUMMARY

According to various embodiments, an electrolyzer system includes electrolyzer cell columns each containing at least one stack of electrolyzer cells that are configured to receive a steam inlet stream and an oxygen inlet stream, and to generate a hydrogen exhaust stream and an air exhaust stream, an air recuperator heat exchanger surrounded by the electrolyzer cell columns and configured to heat the air inlet stream using the oxygen exhaust stream, a steam recuperator heat exchanger surrounded by the electrolyzer cell columns and configured to heat the steam inlet stream using the hydrogen exhaust stream, an outer column heater located radially outward of the electrolyzer cell columns and configured to radiate heat toward radially outward surfaces of the electrolyzer cell columns, and an inner column heater located radially inward of the electrolyzer cell columns, surrounding the air recuperator heat exchanger and the steam recuperator heat exchanger, and configured to radiate heat toward radially inward surfaces of the electrolyzer cell columns.

According to various embodiments, a method of operating an electrolyzer system comprises providing electric power, a steam inlet stream and an air inlet stream to electrolyzer cell columns, each column comprising at least one electrolyzer cell stack, to generate a hydrogen exhaust stream and an oxygen exhaust stream; heating the steam inlet stream in a steam recuperator heat exchanger using the hydrogen exhaust stream; heating the air inlet stream in an air recuperator heat exchanger using the oxygen exhaust stream; heating the steam inlet stream output from the steam recuperator heat exchanger to the electrolyzer cell columns using an outer column heater that surrounds the electrolyzer cell columns; and heating the air inlet stream output from the air recuperator heat exchanger to the electrolyzer cell columns using an inner column heater that is located radially inward of the electrolyzer cell columns and that surrounds the air recuperator heat exchanger and the steam recuperator heat exchanger.

### BRIEF DESCRIPTION OF DRAWINGS

FIG. 1A is a perspective view of a solid oxide electrolyzer cell (SOEC) stack.

FIG. 1B is a side cross-sectional view of a portion of the stack of FIG. 1A.

FIG. 2 is a schematic view of an electrolyzer system, according to various embodiments of the present disclosure.

FIG. 3A is a cross-sectional view showing air flow in a hotbox of the electrolyzer system of FIG. 2, according to various embodiments of the present disclosure.

FIG. 3B is a cross-sectional view showing steam and hydrogen flow in the hotbox of the electrolyzer system of FIG. 2, according to various embodiments of the present disclosure.

FIG. 3C is a top view showing heat transfer in the hotbox of FIG. 2, according to various embodiments of the present disclosure.

FIG. 3D is a perspective view of a distribution hub of FIGS. 3A and 3B, according to various embodiments of the present disclosure.

FIG. 4 is an exploded perspective cross-sectional view of the steam recuperator and air recuperator, according to an alternative embodiment of the present disclosure.

FIG. 5A is a perspective view of an outer column heater, according to various embodiments of the present disclosure.

FIG. 5B is a perspective view of an inner column heater, according to various embodiments of the present disclosure.

FIG. 5C is a perspective view of a base heater, according to various embodiments of the present disclosure.

FIG. 5D is a perspective view of an alternative base heater, according to various embodiments of the present disclosure.

FIG. 6 is a schematic view of an outer column heater and inner column heater having a zoned configuration, according to various embodiments of the present disclosure.

FIG. 7 is a flow diagram illustrating a method of operating an electrolyzer system, according to various embodiments of the present disclosure.

### DETAILED DESCRIPTION

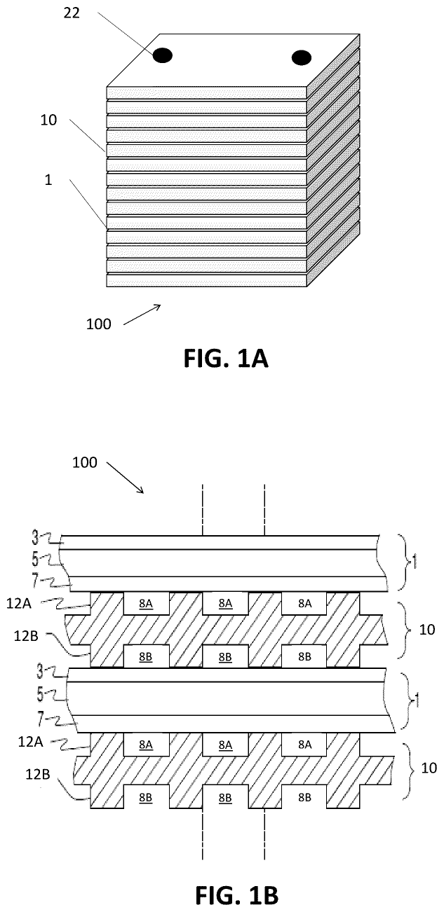

FIG. 1A is a perspective view of an electrolyzer cell stack 100, such as a solid oxide electrolyzer cell (SOEC) stack, and FIG. 1B is a side cross-sectional view of a portion of the stack 100 of FIG. 1A. Referring to FIGS. 1A and 1B, the stack 100 includes multiple electrolyzer cells (e.g., SOECs) 1 that are separated by interconnects 10, which may also be referred to as gas flow separator plates or bipolar plates. Each electrolyzer cell 1 includes an air electrode 3, an electrolyte 5, such as a solid oxide electrolyte for a SOEC, and a fuel electrode 7. The stack 100 also includes internal fuel riser channels 22.

Each interconnect 10 electrically connects adjacent electrolyzer cells 1 in the stack 100. In particular, an interconnect 10 may electrically connect the fuel electrode 7 of one electrolyzer cell 1 to the air electrode 3 of an adjacent electrolyzer cell 1. FIG. 1B shows that the lower electrolyzer cell 1 is located between two interconnects 10.

Various materials may be used for the air electrode 3, electrolyte 5, and fuel electrode 7. For example, the air electrode 3 may comprise an electrically conductive material, such as an electrically conductive perovskite material, such as lanthanum strontium manganite (LSM). Other conductive perovskites, such as LSCo, etc., or metals, such as Pt, may also be used. The electrolyte 5 may comprise a stabilized zirconia, such as scandia stabilized zirconia (SSZ) or yttria stabilized zirconia (YSZ), yttria-ceria-stabilized zirconia (YCSZ), ytterbia-ceria-scandia-stabilized zirconia (YbCSSZ), or blends thereof. In YbCSSZ, scandia may be present in an amount equal to 9 to 11 mol %, such as 10 mol %, ceria may present in amount greater than 0 and equal to or less than 3 mol %, for example 0.5 mol % to 2.5 mol %, such as 1 mol %, and ytterbia may be present in an amount greater than 0 and equal to or less than 2.5 mol %, for example 0.5 mol % to 2 mol %, such as 1 mol %, as disclosed in U.S. Pat. No. 8,580,456, which is incorporated herein by reference. Alternatively, the electrolyte 5 may comprise another ionically conductive material, such as a doped ceria. The fuel electrode 7 may comprise a cermet comprising a nickel containing phase and a ceramic phase. The nickel containing phase may consist entirely of nickel in a reduced state. The ceramic phase may comprise a stabilized zirconia, such as yttria and/or scandia stabilized zirconia and/or a doped ceria, such as gadolinia, yttria and/or samaria doped ceria. The electrodes and the electrolyte may each comprise one or more sublayers of one or more of the above described materials.

Each interconnect 10 includes fuel ribs 12A that at least partially define fuel channels 8A, and air ribs 12B that at least partially define air channels 8B. The interconnect 10 may operate as a gas-fuel separator that separates a fuel, such as steam, flowing to the fuel electrode 7 of one electrolyzer cell 1 in the stack 100 from oxidant, such as air, flowing to the air electrode 3 of an adjacent electrolyzer cell 1 in the stack 100. At either end of the stack 100, there may be an air end plate or fuel end plate (not shown) for providing air or fuel, respectively, to the end electrode.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may comprise a metal (e.g., a chromium-iron alloy, such as 4-6 weight percent iron, optionally 1 or less weight percent yttrium and balance chromium alloy). Alternatively, any other suitable conductive interconnect material, such as stainless steel (e.g., ferritic stainless steel, SS446, SS430, etc.) or iron-chromium alloy (e.g., Crofer™ 22 APU alloy which contains 20 to 24 wt. % Cr, less than 1 wt. % Mn, Ti and La, and balance Fe, or ZMG™ 232L alloy which contains 21 to 23 wt. % Cr, 1 wt. % Mn and less than 1 wt. % Si, C, Ni, Al, Zr and La, and balance Fe).

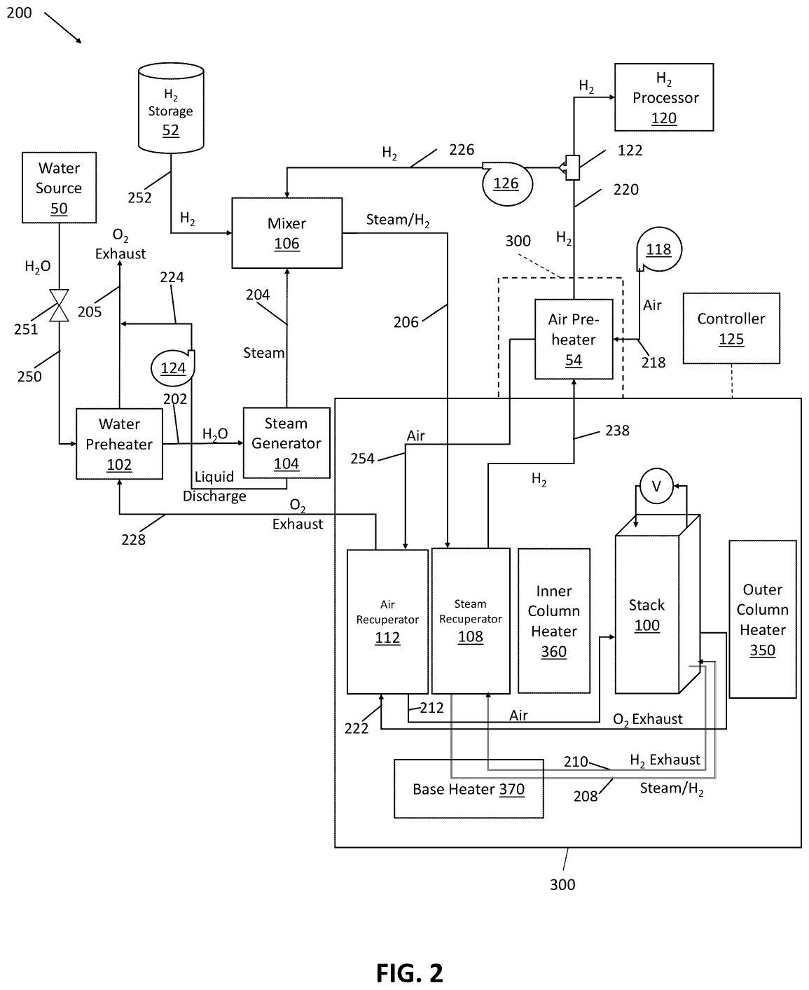

FIG. 2 is schematic view of an electrolyzer system 200, according to various embodiments of the present disclosure. Referring to FIGS. 1A, 1B, and 2, the system 200 may include one or more electrolyzer cell stacks 100 or columns, such as SOEC stacks or columns. Each column may include one or more electrolyzer cell stacks 100. The electrolyzer cell stack 100 includes multiple electrolyzer cells, such as SOECs, as described with respect to FIGS. 1A and 1B. The system 200 may also include a steam generator 104, a steam recuperator heat exchanger 108, an air recuperator heat exchanger 112, an air blower 118, a recycle blower 126, an outer column heater 350, an inner column heater 360, and a base heater 370. The system 200 may also optionally include at least one of an air pre-heater heat exchanger 54, a water preheater heat exchanger 102, a mixer 106, a hydrogen processor 120 and/or a hydrogen separator (e.g., splitter or valve) 122.

The system 200 may include a hotbox 300 that houses various components, such as the stack 100, the steam recuperator 108, the air recuperator 112, the outer column heater 350, the inner column heater 360 and/or the base heater 370. In some embodiments, the hotbox 300 may include multiple stacks 100 or multiple columns of stacks 100. The water preheater 102 and the steam generator 104 may be located external to the hotbox 300, as shown in FIG. 2. Alternatively, the water preheater 102 and/or the steam generator 104 may be located inside the hotbox 300. In another alternative embodiment, the SOEC system may have an external steam source, in which case the water preheater 102 and/or the steam generator 104 may be omitted.

During operation, the stack 100 may be provided with steam (e.g., steam inlet stream) and electric power (e.g., current or voltage) from an external power source. In particular, the steam may be provided to the fuel electrodes 7 of the electrolyzer cells 1 of the stack 100, and the power source may apply a voltage between the fuel electrodes 7 and the air electrodes 3, in order to electrochemically split water (e.g., steam) molecules and generate hydrogen and oxygen. Air may also be provided to the air electrodes 3, in order to sweep the oxygen from the air electrodes 3. As such, the stack 100 may output a hydrogen stream and an oxygen-rich exhaust stream, such as an oxygen-rich air stream (“oxygen exhaust stream”).

In order to generate the steam, water may be provided to the system 200 from a water source 50. The water source 50 may include a municipal water supply (e.g., water pipe) and/or a water storage tank. The water may be deionized (DI) water that is deionized as much as is practical (e.g., <0.1 μS/cm), in order to prevent and/or minimize scaling during vaporization. In some embodiments, the water source 50 may include one or more deionization beds (e.g., downstream of the water pipe or tank). The water source 50 may provide the water to the system 200 via a water inlet conduit 250. In various embodiments, the water inlet conduit 250 may include a water flow control device 251 such as a valve, a mass flow controller, a positive displacement pump, a water flow meter, or the like, in order to provide a desired water flow rate to the system 200.

If the system 200 includes the water preheater 102, the water may be provided from the water source 50 to the water preheater 102 through the water inlet conduit 250. The water preheater 102 may be a heat exchanger configured to heat the water using heat recovered from the oxygen exhaust stream from the stack 100. Preheating the water may reduce the total power consumption of the system 200 per unit of hydrogen generated. In particular, the water preheater 102 may recover heat from the oxygen exhaust stream that may not be recoverable by the air recuperator 112, as discussed below. The water preheater may heat the water to a temperature above 50° C., such as a temperature of about 70° C. to 80° C. The oxygen exhaust stream may be output from the water preheater 102 at a temperature above 80° C., such as above 100° C., such as a temperature of about 120° C. to 140° C.

The water output from the water preheater 102 (or from the water source 50 if the water preheater 102 is omitted) may be provided to the steam generator 104 through a water conduit 202. The steam generator 104 may be configured to heat the water to convert the water into steam. The steam generator 104 may include a heating element to vaporize the water and generate steam. For example, the steam generator 104 may include an AC or DC resistance heating element or an induction heating element. Alternatively, the steam generator 104 may comprise a heat exchanger which is located inside the hotbox 300 and which is heated by one or more hot exhaust streams flowing through the hotbox 300. The steam generator 104 heats the water above 100°° C. to generate steam, such as a temperature of about 120° C. to 145° C.

The steam generator 104 may include multiple zones/elements that may or may not be mechanically separate. For example, the steam generator 104 may include a pre-boiler to heat the water up to or near to the boiling point. The steam generator 104 may also include a vaporizer configured to convert the pre-boiled water into steam. The steam generator 104 may also include a deaerator to provide a relatively small purge of steam to remove dissolved air from the water prior to bulk vaporization. The steam generator 104 may also include an optional superheater configured to further increase the temperature of the steam generated in the vaporizer. The steam generator 104 may include a demister pad located downstream of the heating element and/or upstream from the super heater. The demister pad may be configured to minimize entrainment of liquid water in the steam output from the steam generator 104 and/or provided to the superheater.

If the steam product is superheated, it will be less likely to condense downstream from the steam generator 104 due to heat loss. Avoidance of condensation is preferable, as condensed water is more likely to form slugs of water that may cause significant variation of the delivered mass flow rate with respect to time. It may also be beneficial to avoid excess superheating, in order to limit the total power consumption of the system 200. For example, the steam may be superheated by an amount ranging from about 10° C. to about 100° C.

In some embodiments, a small amount of liquid water (e.g., from about 0.5% to about 2% of incoming water) may be periodically or continuously discharged from the steam generator 104 via a liquid discharge conduit 224. In particular, the discharged liquid water may include scale and/or other mineral impurities that may accumulate in the steam generator 104 while vaporizing water to generate steam. Therefore, this discharged liquid water is not desirable for being recycled into the water inlet stream from the water source 50. This liquid discharge may be mixed with the hot oxygen exhaust stream output from the water preheater 102 into an exhaust conduit 205. If the hot oxygen exhaust stream has a temperature above 100° C., such as 120 to 140° C., the liquid water discharge may be evaporated by the hot oxygen exhaust stream, such that no liquid water is required to be discharged from the system 200. The system 200 may optionally include a water pump 124 configured to pump and regulate the liquid water discharge in the liquid discharge conduit 224 output from the steam generator 104 into the exhaust conduit 205 from the water preheater 102. Optionally, a flow regulator, such as proportional solenoid valve, may be added to the liquid discharge conduit 224 in addition to the pump 124 to additionally regulate the flow of the liquid water discharge.

Blowdown from the steam generator 104 may be beneficial for long term operation, as the water will likely contain some amount of mineralization after deionization. Typical liquid blowdown may be on the order of 1%. The blowdown may be continuous, or may be intermittent, e.g., ten times the steady state flow for 6 seconds out of every minute, five times the steady state flow for 1 minute out of every 5 minutes, etc. The need for a water discharge stream can be eliminated by pumping the blowdown into the hot oxygen exhaust. In this case, the pump 124 and liquid discharge conduit 224 may be omitted.

The steam output from the steam generator 104 may be provided to the steam recuperator 108 via a steam conduit 204. However, if the system 200 includes the optional mixer 106, the steam may be provided to the mixer 106 prior to being provided to the steam recuperator 108. In particular, the steam may include small amounts of dissolved air and/or oxygen. The mixer 106 may be configured to mix the steam with hydrogen gas, in order to maintain a reducing environment in the stack 100, and in particular, at the fuel electrodes 7.

The mixer 106 may be configured to mix the steam with hydrogen received from a hydrogen storage device (e.g., hydrogen storage vessel) 52 and/or with a portion of the hydrogen and stream recycle stream output from the stack 100. The hydrogen addition rate may be set to provide an amount of hydrogen that exceeds an amount of hydrogen needed to react with an amount of oxygen dissolved in the steam. The hydrogen addition rate may either be fixed or set to a constant water to hydrogen ratio. However, if the steam is formed using water that is fully deaerated, the mixer 106 and/or hydrogen addition into the steam may optionally be omitted.

In some embodiments, the hydrogen may be provided to the mixer 106 during system startup and shutdown modes, and optionally during steady-state operation modes. For example, during the startup and shutdown modes (or other modes where the system 200 is not generating hydrogen, such as a fault mode), the hydrogen may be provided to the mixer 106 from the hydrogen storage device 52 via a stored hydrogen conduit 252.

During the steady-state operating mode, the hydrogen flow from the hydrogen storage device 52 may be stopped (e.g., by shutting off the outlet valve from the hydrogen storage device). Instead, a first portion of a hydrogen exhaust stream (e.g., the hydrogen and steam product steam) generated by the stack 100 is diverted to the mixer 106 through the hydrogen recycle conduit 226 by the recycle blower 126. In particular, the system 200 may include a hydrogen separator 122, such as a splitter and/or valve, configured to selectively divert a portion of the hydrogen exhaust stream flowing through the hydrogen product conduit 220 to the mixer 106 during the steady-state mode operation.

The mixed steam and hydrogen inlet stream is provided from the mixer 106 into a steam recuperator heat exchanger 108 via a steam and hydrogen conduit 206. The mixed steam and hydrogen inlet stream in conduit 206 may have a temperature above 100° C., such as 120° C. to 140° C. The mixed steam and hydrogen inlet stream is heated in the steam recuperator 108 by the hydrogen exhaust (i.e., the hydrogen and steam product stream) provided from the stack 100. The hydrogen exhaust may be provided from the stack 100 to the steam recuperator 108 via a hydrogen outlet conduit 210. The heated mixed steam and hydrogen inlet stream is provided from the steam recuperator heat exchanger 108 into the fuel side inlet of the stack 100 via the fuel inlet conduit 208. The mixed steam and hydrogen inlet stream in the fuel inlet conduit 208 may have a temperature above 500° C., such as 550° C. to 600° C.

The hydrogen exhaust is output from the hotbox 300 (e.g., from the steam recuperator 108 and/or the optional air preheater 54) into the hydrogen product conduit 220 at a temperature of 150° C. to 250° C. A second portion of the hydrogen exhaust that is not diverted by the hydrogen separator 122 into the mixer 106 continues through the hydrogen product conduit 220 into the hydrogen processor 120. The hydrogen exhaust may be compressed and/or purified in the hydrogen processor 120. The hydrogen processor 120 may include a high temperature hydrogen pump that operates at a temperature of from about 120° C. to about 200° C., in order to remove from about 70% to about 90% of the hydrogen from the hydrogen exhaust. The removed hydrogen is stored and/or provided for one or more end uses. In one embodiment, the hydrogen processor 120 includes an electrochemical hydrogen pump, a liquid ring compressor, a diaphragm compressor or combination thereof. For example, the hydrogen processor may include a series of electrochemical hydrogen pumps, which may be disposed in series and/or in parallel with respect to a flow direction of the hydrogen exhaust, in order to compress the hydrogen exhaust. The final product from compression may still contain traces of water. As such, the hydrogen processor 120 may optionally include a dewatering device, such as a condenser, a temperature swing adsorption reactor or a pressure swing adsorption reactor, to remove this residual water, if necessary.

The air recuperator heat exchanger 112 may be provided with ambient air by an air blower 118 via an air inlet conduit 218 and an optional preheated air conduit 254. The oxygen exhaust output from the stack 100 may be provided to the air recuperator 112 via an oxygen outlet conduit 222. The air recuperator 112 may be configured to heat the air using heat extracted from the stack oxygen exhaust (i.e., the oxygen enriched air). The air inlet stream may be heated in the air recuperator 112 to a temperature above 500° C., such as 550° C. to 600° C. The heated air inlet stream is provided from the air recuperator 112 to the air inlet of the stack 100 via the stack air inlet conduit 212.

The oxygen exhaust is output from the air recuperator 112 to the water preheater 102 via the oxygen exhaust conduit 228 at temperature above 200° C., such as 250° C. to 350° C. The oxygen exhaust is output from the water preheater 102 via the exhaust conduit 205 at temperature of at least 80° C., such as 120° C. to 140° C.

According to various embodiments, the system 200 may include an optional air preheater heat exchanger 54 disposed outside or inside of the hotbox 300. In particular, the air preheater 54 may be configured to preheat the air inlet stream provided to the hotbox 300 by the air blower 118 via the air inlet conduit 218 using heat in the hydrogen exhaust (i.e., the hydrogen and steam product stream) from the stack 100. The air may be preheated in the air preheater to a temperature above 100° C., such as 150° C. to 250° C. The hydrogen exhaust may be provided from the steam recuperator 108 to the air preheater 54 via a hydrogen conduit 238.

According to various embodiments, the system 200 may include a controller 125, such as a central processing unit, which is configured to control the operation of the system 200. For example, the controller 125 may be wired or wirelessly connected to various elements of the system 200 to control the same.

### Electrolyzer Thermal Control

According to various embodiments, the SOEC stack 100 may most efficiently generate hydrogen at an operating temperature ranging from about 700° C. to 900°° C., such as from about 725° C. to about 775° C., or about 750° C. In order to maintain the stack operating temperature, fluids provided to the stack 100 may be heated by various components prior to being provided to the stack 100.

However, the present inventors determined that size constraints within the hotbox 300 may limit the maximum size of the steam recuperator 108 and the air recuperator 112. As such, it may be difficult to achieve desired steam and air output temperatures, while at the same time providing a high flow rate and a low pressure drop for efficient system operation. For example, in order for a small sized recuperator to have a high output temperature, the recuperator may have a high pressure drop and/or a low flow rate. As such, hotbox size limitations may make it difficult for recuperators to output steam and air at stack operating temperatures and at desired flow rates, without having an undesirably high pressure drop. Various embodiments of the present disclosure provide various thermal control components, such as the heaters 350, 360, 370 and air recuperator 112 located radially inwards from the stacks 100, which improve the temperature control of the system.

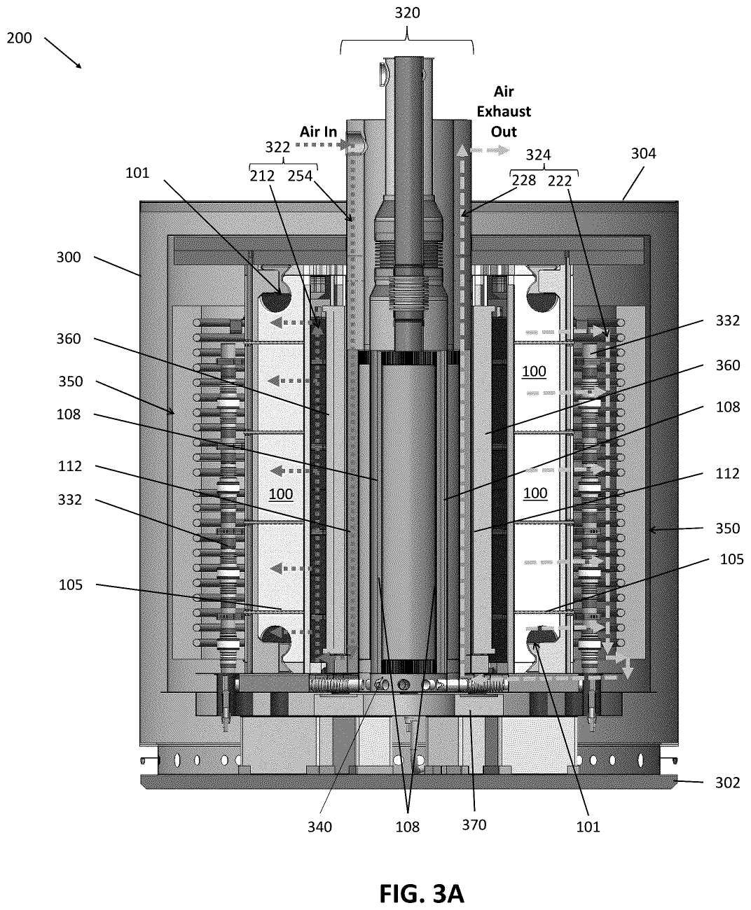

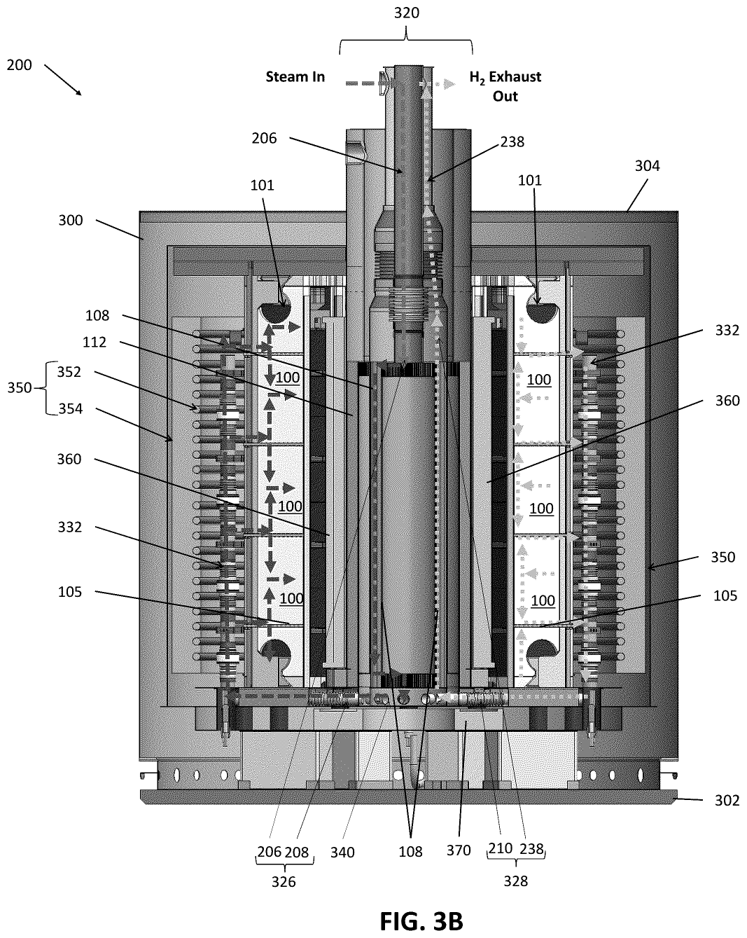

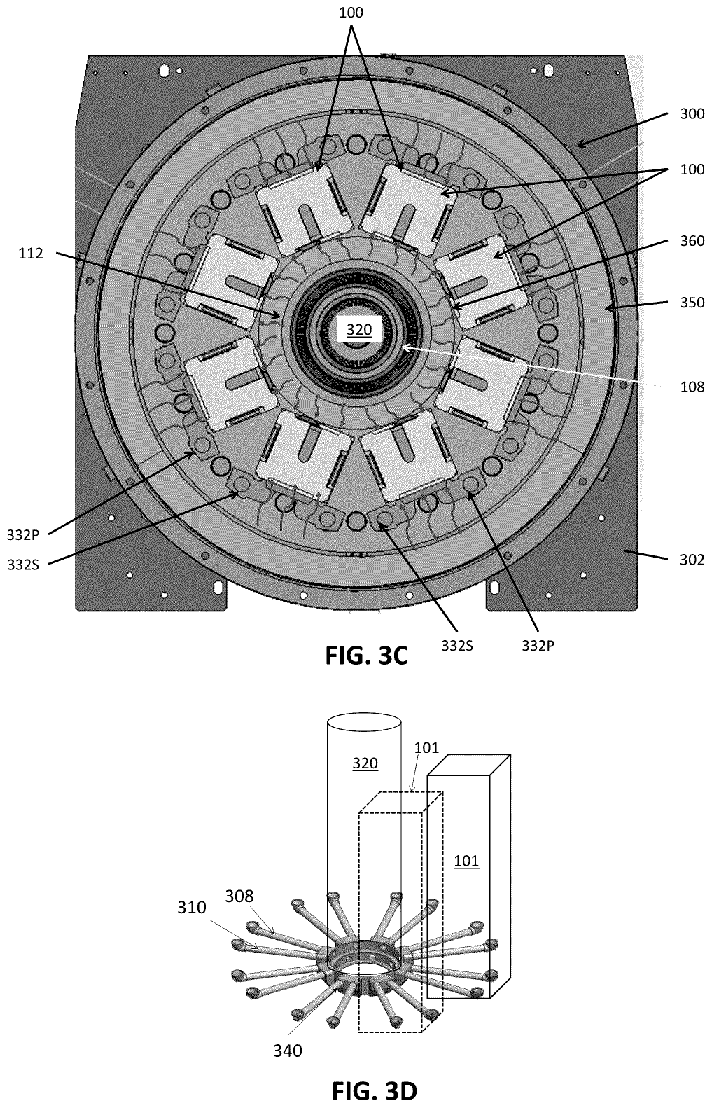

FIGS. 3A and 3B are cross-sectional views showing air flow and steam and hydrogen flow in the hotbox 300 of the electrolyzer system 200 of FIG. 2, according to various embodiments of the present disclosure. FIG. 3C is a top view showing heat transfer in the hotbox of FIG. 2, according to various embodiments of the present disclosure.

Referring to FIGS. 3A-3C, the hotbox 300 may be disposed on an optional support base 302 and may include an optional cover plate 304. The support base 302 may comprise hollow rails which provide access for a forklift to raise and move the hotbox 300. The system 200 includes a central column 320, an outer column heater 350, an inner column heater 360, and a base heater 370, which may be disposed in the hotbox 300. In particular, the central column 320 may protrude through an opening in the cover plate 304 of the hotbox 300.

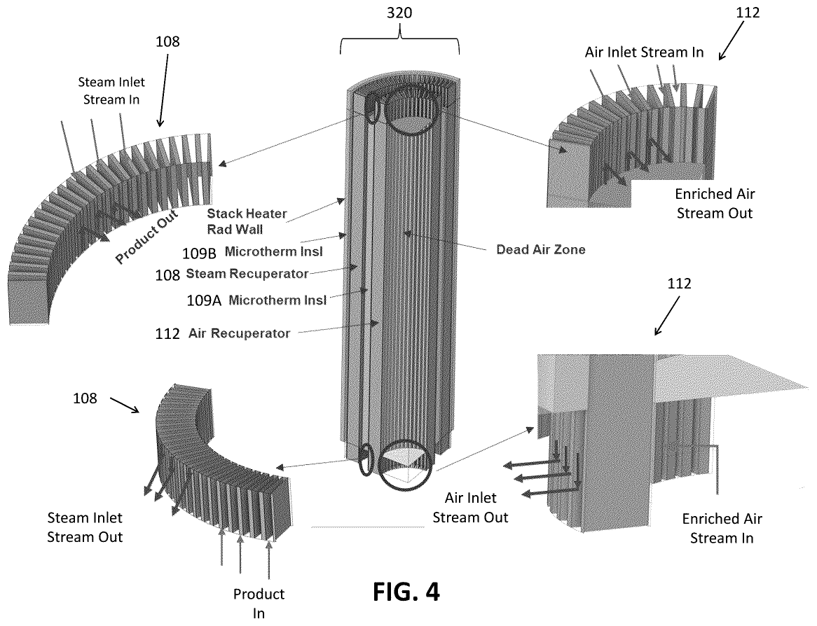

The central column 320 may include a steam recuperator 108 and an air recuperator 112. In various embodiments, the air recuperator 112 may be located radially outward from and concentrically surround the steam recuperator 108. It is believed that this configuration may provide a high heat transfer efficiency. However, in an alternative embodiment shown in FIG. 4 and described below, the air recuperator 112 may optionally be located radially inward from and be laterally surrounded by the steam recuperator 108 instead. Thus, both the steam recuperator 108 and the air recuperator 112 are located radially inward of the stacks 100 or cell columns 101. The central column 320 may also include an air conduit 322, an air exhaust conduit 324, a steam conduit 326, and a product conduit 328. The air conduit 322 comprises a combination of the preheated air conduit 254 and the stack air inlet conduit 212. The air exhaust conduit 324 comprises a combination of the oxygen outlet conduit 222 and the oxygen exhaust conduit 228. The steam conduit 326 comprises a combination of the steam and hydrogen conduit 206 and the fuel inlet conduit 208. The product conduit 328 comprises a combination of the hydrogen outlet conduit 210 and the hydrogen conduit 238.

The cell columns 101 may each include one stack 100 or plural stacks 100 stacked over each other. The cell columns 101 surround around the central column 320. The cell columns 101 may optionally include fuel manifolds 105 (e.g., steam splitter plates) disposed between the stacks 100. The manifolds 105 may be configured to provide steam to adjacent stacks 100 in the same column 101 and receive the hydrogen product output from adjacent stacks 100 in the same column 101. The manifolds 105 of each cell column 101 may be fluidly connected to riser conduits 332 configured to provide the steam to and collect the hydrogen exhaust from the cell columns 101. The riser conduits 332 may include steam riser conduits 332S configured to provide the steam inlet stream to the cell columns 101, and product riser conduits 332P configured to collect the hydrogen exhaust stream (i.e., the hydrogen product stream) output from the cell columns 101, as shown in FIG. 3C.

Thus, the cell columns 101 and/or stacks 100 may be internally manifolded for steam/hydrogen and externally manifolded for oxygen/air. As noted above, the steam inlet stream may also include hydrogen, and the hydrogen product may also include unreacted steam. Alternatively, each cell column 101 may include only one stack 100 and the manifolds 105 and riser conduits 332 may be omitted. In another alternative embodiment, the cell columns 101 and/or stacks 100 may be internally manifolded for both steam/hydrogen and oxygen/air using interconnects and stacks such as those disclosed in U.S. Provisional Application No. 63/598,678 (Internally Manifolded Interconnects with Plural Flow Directions And Electrochemical Cell Column Including Same), filed on Nov. 14, 2023, the contents of which are incorporated herein by reference in their entirety.

Referring to FIG. 3D, the central column 320 may be disposed on and fluidly connected to a distribution hub 340. The distribution hub 340 may be configured to fluidly connect the central column 320 to the stacks 100 or columns 101. While only two columns 101 are shown in FIG. 3D, the distribution hub 340 may be fluidly connected to all the stacks 100 or columns 101 included in the hotbox 300. The distribution hub 340 may be fluidly connected to the riser conduits 332 by the fuel inlet conduits (i.e., steam distribution conduits) 208 and hydrogen outlet conduits (i.e., product collection conduits) 310 as shown in FIG. 3B. In particular, the fuel inlet conduits 208 may be fluidly connected to the steam riser conduits 332S, and the hydrogen outlet conduits 210 may be fluidly connected to the product riser conduits 332P.

The fuel inlet conduits 208 may be configured to distribute steam output from the steam and hydrogen conduit 206 and the steam recuperator 108 in the central column 320 through the distribution hub 340 to the riser conduits 332. The hydrogen outlet conduits 210 may be configured to receive the hydrogen exhaust stream generated by the stacks 100 and output through the product riser conduits 332P and the distribution hub 340 to the steam recuperator 108 and the hydrogen conduit 238.

The inner column heater 360 may be disposed between the central column 320 and the cell columns 101 (e.g., one or more stacks 100). In particular, an inner surface of the inner column heater 360 may face the steam recuperator 108 and the air recuperator 112, and an outer surface of the inner column heater 360 may face the stacks 100 or columns 101. The outer column heater 350 may surround the stacks 100 or columns 101. In particular, an inner surface of the outer column heater 350 may face the stacks 100. Thus, the stacks 100 or columns 101 are located radially inward from the outer column heater 350 and radially outward from the inner column heater 360. The steam recuperator 108 and the air recuperator 112 are located radially inward from the inner column heater 360.

As shown in FIG. 3A, in operation, an incoming air inlet stream is provided through the air conduit 322 (e.g., through the preheated air conduit 254) to the top of the air recuperator 112. The air inlet stream may be heated while passing through the air recuperator 112, before exiting the bottom of the air recuperator 112. After exiting the air recuperator 112, the air inlet stream may flow upward through the stack air inlet conduit 212 to the inner facing surfaces of the stacks 100 or columns 101. The inner column heater 360 may heat the air inlet stream in the stack air inlet conduit 212. The air inlet stream may enter the open inner (i.e., radially inward) surfaces of the stacks 100 or columns 101 that face the central column 320. Oxygen ions generated from the steam inlet stream at the fuel electrodes 7 by a voltage applied to the stacks 100 may pass through the SOEC electrolytes 5 and may recombine to form oxygen gas (O₂) at the air electrodes 3. The oxygen gas is swept away by the air inlet stream flowing through the stacks 100. The oxygen enriched air (e.g., oxygen/air exhaust) stream then exits outer (i.e., radially outward) surfaces of the stacks 100, flows downward through the oxygen outlet conduit 222 toward the bottom of the hotbox 300, and then flows into the bottom of the air recuperator 112. The outer column heater 350 may heat the oxygen enriched air in the oxygen outlet conduit 222. The air recuperator 112 extracts heat from the oxygen exhaust stream as it flows upward through the air recuperator 112, to heat the incoming air inlet stream.

As shown in FIG. 3B, in operation, steam and/or a steam/hydrogen mixture is provided to the central column 320 flows downward through the steam conduit 326 (e.g., through the steam and hydrogen conduit 206) to the steam recuperator 108. The steam recuperator 108 may be a heat exchanger configured to recover heat from the hydrogen exhaust stream output from the stacks 100 or columns 101. As such, the steam recuperator 108 may be configured to increase the efficiency of the system 200.

The heated steam inlet stream may exit the bottom of the steam recuperator 108 and enter the distribution hub 340. The steam inlet stream may then flow through the fuel inlet conduits 208 to the corresponding riser conduits 332 (e.g., steam riser conduits 332S), which provide the steam inlet stream to the stacks 100 or columns 101. The steam and/or the steam/hydrogen mixture (i.e., the steam inlet stream) flowing through the fuel inlet conduits 208 is heated by the base heater 370 located adjacent to the distribution hub 340. The stacks 100 or columns 101 may convert at least a portion of the steam into hydrogen to generate a hydrogen exhaust stream (i.e., product stream) that may also comprise unreacted steam. The hydrogen exhaust stream may be output from the stacks 100 or columns 101 to the corresponding riser conduits 332 (e.g., product riser conduits 332P). The hydrogen exhaust stream may be provided from the product riser conduits 332P to the distribution hub 340 by the hydrogen outlet conduits 210, which may provide the hydrogen exhaust stream to the bottom of the steam recuperator 108. The hydrogen exhaust stream flowing through the hydrogen outlet conduits 210 is heated by the base heater 370 located adjacent to the distribution hub 340. The hydrogen exhaust stream may flow up through the steam recuperator 108, which may transfer heat from the hydrogen exhaust stream to the incoming steam inlet stream flowing therethrough in the opposite direction. The hydrogen exhaust stream may exit the top of the steam recuperator 108 and enter the hydrogen conduit 238 and then exit the central column 320.

In various embodiments, in order for the recuperators 108, 112 to provide high steam and air flow rates and a low pressure drop while also fitting within the space available in the hotbox 300, the temperature of the output steam inlet stream and/or air inlet stream may be less than a desired operating temperature of the stacks 100 or columns 101. Accordingly, the heaters 350, 360, 370 may be used to supplement that heating provided by the recuperators 108, 112.

For example, the heaters 350, 360, 370 may be configured to heat the air inlet stream, the steam/hydrogen stream (i.e., the steam inlet stream), the hydrogen exhaust stream and/or the oxygen enriched air stream (i.e., oxygen exhaust stream) such that the steam inlet stream and the air inlet stream are provided to the stacks 100 at temperatures as close as possible to the operating temperature of the stack, such as at temperatures ranging from about 700° C. to about 900° C., such as from about 725° C. to about 850° C., or about 750° C. However, higher temperatures may also be used.

In various embodiments, the heaters 350, 360, 370 may include electric heating elements, such as resistive or inductive heating elements which may be embedded in thermal insulation layers. In some embodiments, the heaters 350, 360, 370 may preferably comprise heating elements disposed in a ceramic fiber insulation material, in order to provide longer heater life. For example, as shown in FIG. 3B, the outer column heater 350 may include one or more heating elements 352 embedded in a tubular insulation layer 354, which may be formed of ceramic fibers.

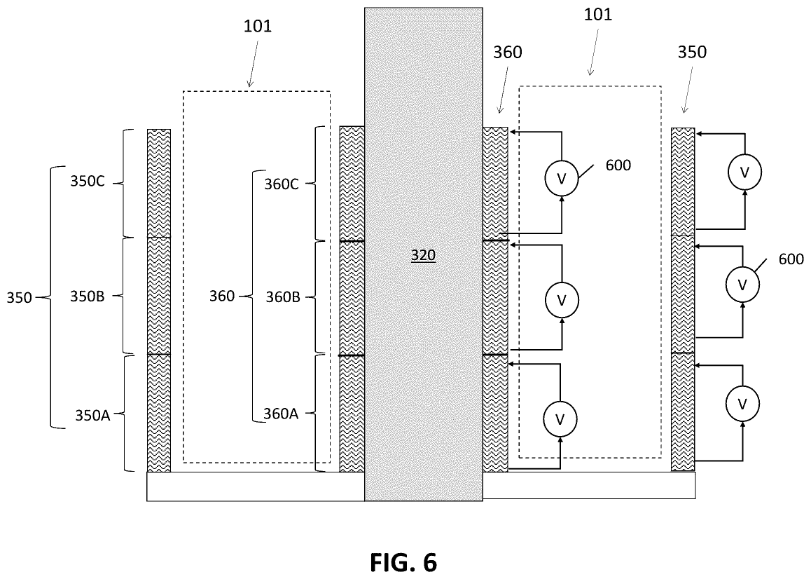

In some embodiments, the heaters 350, 360, 370 may include different heating zones in order to provide improved temperature control. For example, the column heaters 350, 360 may have upper, middle, and lower zones, including independently controllable heating elements, in order to heat upper, middle, and lower portions of the stacks 100 at different temperatures, depending on the temperature requirements of different portions of the stacks 100, as will be described in more detail below with respect to FIG. 6. In such embodiments, system 200 controller 125 is configured to independently control the upper, middle, and lower heating zone temperatures for each column heater 350, 360.

In various embodiments, the outer column heater 350 may be disposed along the perimeter of the hotbox 300 and may be configured to radiate heat inward toward the central column 320 and the cell columns 101. For example, the outer column heater 350 may be configured to radiate heat toward the outer (i.e., radially outward) surfaces of the stacks 100, columns 101 and/or the riser conduits 332. Accordingly, the outer column heater 350 may be configured to heat the stacks 100 or columns 101 and fluids flowing through the riser conduits 332. The base heater 370 may be configured to heat fluids flowing through the distribution hub 340. For example, the base heater 370 may directly or indirectly heat the conduits 208 and 210 to heat the fluids flowing therethrough. For example, the base heater 370 may be configured to heat a steam/hydrogen mixture (i.e., the steam inlet stream) flowing through the fuel inlet conduits 208 up to the stack operating temperature. In some embodiments, the base heater 370 may also heat the hydrogen exhaust stream flowing through the hydrogen outlet conduits 210, in order to increase the amount of heat transferred to the steam inlet stream in the steam recuperator 108.

For example, depending on the health of the stacks 100, the water utilization rate of the stacks 100, and the air flow rate to the stacks 100, the outer column heater 350 and/or base heater 370 may heat steam or steam/hydrogen mixture provided to the stacks 100 to a temperature ranging from about 700°° C. to about 900° C., such as 725° C. to 800° C., or about 750° C. In some embodiments, the outer column heater 350 and/or base heater 370 may increase the temperature of the steam output from the steam recuperator 108 by an amount ranging from about 50° C. to about 300° C., such as from about 75° C. to about 200°° C., or from about 100° C. to about 150° C. Accordingly, the stacks 100 may be provided with steam or a steam-hydrogen mixture having a temperature that allows for efficient hydrogen generation.

The inner column heater 360 may surround the central column 320, such that an outer surface of inner column heater 360 faces inner (i.e., radially inward) surfaces of the stacks 100 or columns 101 and an inner surface of the inner column heater 360 faces the central column 320 and/or the air recuperator 112. The inner column heater 360 may be configured to heat the stacks 100 or columns 101, for example, by radiating heat outward toward the inner surfaces of the stacks 100 or columns 101. The inner column heater 360 may also heat the air recuperator 112, in order to increase the temperature of the air inlet stream flowing along the outer surface of the air recuperator 112.

In some embodiments, the inner column heater 360 may be configured to heat the air inlet stream provided to the stacks 100, including air in the air recuperator 112 and/or the air inlet stream flowing through the hotbox 300, to a temperature ranging from about 700° C. to about 900° C., such as 725° C. to 800° C., or about 750°° C. For example, the inner column heater 360 may be configured to increase the temperature of the air inlet stream output from the air recuperator 112 by an amount ranging from about 100° C. to about 400° C., such as from about 150° C. to about 350° C., or from about 250° C. to about 275° C.

Accordingly, the heaters 350, 360, 370 may be configured to utilize radiant and/or conductive heat transfer to heat the stacks 100 or columns 101, and/or steam inlet stream and air inlet stream provided to the stacks 100 or columns 101, to maintain a desired stack operating temperature and hydrogen production efficiency, without increasing a footprint and/or volume of the hotbox 300. Accordingly, the heaters 350, 360, 370 may beneficially allow for the use of relatively small recuperators 108, 112, while maintaining overall system space and hydrogen production efficiency.

FIG. 4 is an exploded cross-sectional view showing the steam recuperator 108 and the air recuperator 112 of the central column 320 according to an alternative embodiment. In the alternative embodiment, the steam recuperator 108 surrounds and is located radially outward of the air recuperator 112.

The steam recuperator 108 and the air recuperator 112 may be separated by an inner insulation layer 109A, and an outer insulation layer 109B may cover the outer surface of the steam recuperator 108. In some embodiments, the insulation layers 109A, 109B may be formed of a microthermal insulation material and may have a thickness ranging from about 3 mm to about 20 mm, such as from about 5 mm to about 15 mm. For example, the inner insulation layer 109A may have a thickness ranging from about 5 mm to about 15 mm, such as from about 8 mm to about 12 mm, or about 10 mm. The outer insulation layer 109B may have a thickness ranging from about 3 mm to about 9 mm, such as from about 4 mm to about 8 mm, or about 6 mm. The outer surface of the outer insulation layer 109B may be configured to contact the inner column heater 360.

The steam recuperator 108 and the air recuperator 112 may be metallic heat exchangers, such as finned or corrugated heat exchangers or the like. The steam recuperator 108 may be configured to transfer heat between a hydrogen product (i.e., hydrogen exhaust stream) flowing along its inner surface and steam and/or a steam/hydrogen mixture (i.e., steam inlet stream) flowing along its outer surface. In some embodiments, a dead air zone may be formed inside of the central column 320. The air recuperator 112 may be configured to transfer heat between an enriched air stream (i.e., oxygen exhaust stream) flowing along its inner surface and the air inlet stream flowing along its outer surface.

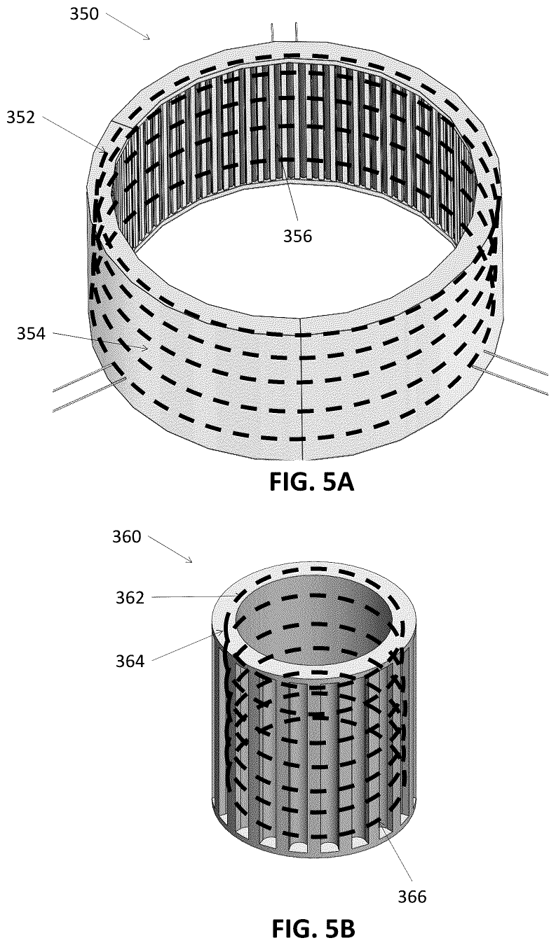

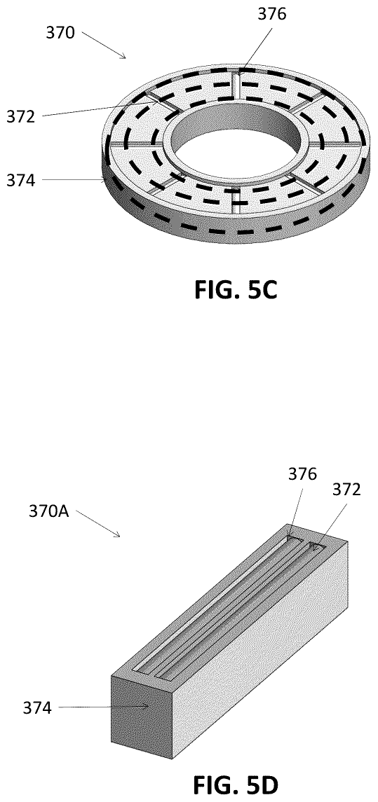

FIG. 5A is a perspective view of an outer column heater 350, according to various embodiments of the present disclosure. FIG. 5B is a perspective view of an inner column heater 360, according to various embodiments of the present disclosure. FIG. 5C is a perspective view of a base heater 370, according to various embodiments of the present disclosure. FIG. 5D is a perspective view of an alternative base heater unit 370A, according to various embodiments of the present disclosure.

Referring to FIGS. 3B and 5A, the outer column heater 350 may have a generally cylindrical structure. The outer column heater 350 may include one or more heating elements 352 embedded in a tubular insulation layer 354, such as a ceramic fiber insulation layer. The outer column heater 350 may also include channels 356 formed in an inner surface that faces the stacks 100 or columns 101. The channels 356 may increase the surface area of the inner surface of the outer column heater 350, and thereby increase the heat transfer efficiency of the outer column heater 350.

Referring to FIGS. 3B and 5B, the inner column heater 360 may have a generally cylindrical structure. The inner column heater 360 may include one or more heating elements 362 embedded in a tubular insulation layer 364, such as a ceramic fiber insulation layer. The inner column heater 360 may also include channels 366 formed in an outer surface that faces the stacks 100 or columns 101. The channels 366 may increase the surface area of the outer surface of the inner column heater 360, and thereby increase the heat transfer efficiency of the inner column heater 360.

Referring to FIGS. 3B and 5C, the base heater 370 may have a hollow disk-shaped structure. The base heater 370 may include one or more heating elements 372 embedded in an insulation layer 374, such as a ceramic fiber insulation layer. The base heater 370 may also include channels 376 formed in an upper surface thereof. The channels 376 may increase the surface area of the outer surface of the base heater 370, and/or may be configured to receive the conduits 208 and/or 210, to thereby increase the heat transfer efficiency of the base heater 370.

Referring to FIGS. 3B and 5D, an alternative base heater includes plural base heater units 370A having a generally prismatic shape. The base heater units 370A may include one or more heating elements 372 embedded in an insulation layer 374, such as a ceramic fiber insulation layer. The base heater units 370A may also include channels 376 formed in an upper surface thereof and configured to receive two of the conduits 208 and/or 210. Accordingly, the system 200 may include multiple base heater units 370A, based on the number of conduits 208 and 212.

FIG. 6 is a schematic view of an outer column heater 350 and inner column heater 360 having a zoned configuration, according to various embodiments of the present disclosure. Referring to FIG. 6, the heaters 350, 360 may have two or more heating regions. For example, the outer column heater 350 may include a lower heating region 350A, a middle heating region 350B, and an upper heating region 350C, and the inner column heater 360 may include a lower heating region 360A, a middle heating region 360B, and an upper heating region 360C. Heating elements included in each of the regions may be independently connected to a voltage source 600. The heating elements of each region may be independently controlled by the controller 125, in order to independently control an amount of heat generated by each region of the heaters 350, 360. As such, the heaters 350, 360 may radiate different amounts of heat to different portions of the stacks 100 or columns 101 and/or different portions of the central column 320. The system may include temperature sensors to monitor the various zones in order to provide feedback to the controller 125 so that it can adjust the amount of heating provided to the different regions accordingly.

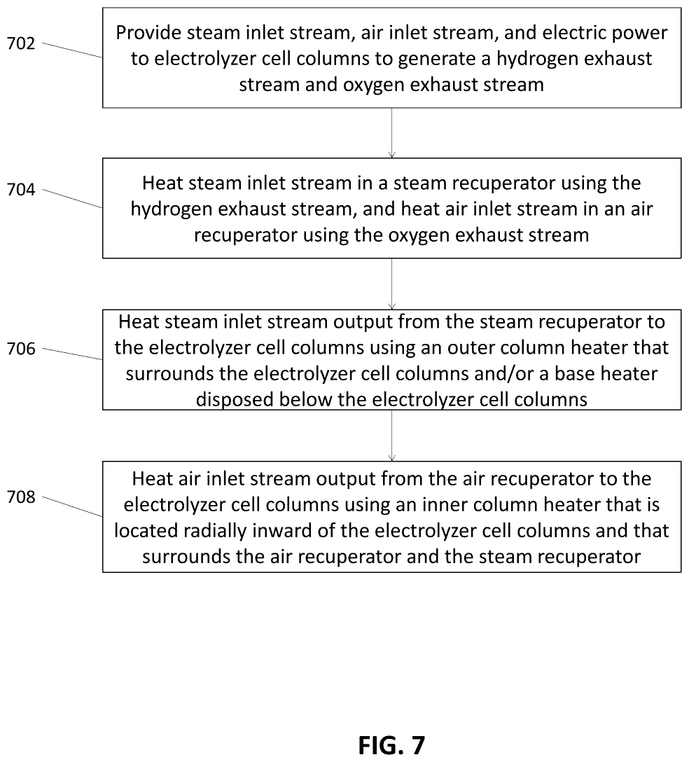

FIG. 7 is a flow diagram illustrating a method of operating an electrolyzer system, according to various embodiments of the present disclosure. The method will be described with respect to the system 200 described above. However, the method may be performed using other suitable electrolyzer systems.

Referring to FIGS. 3A, 3B, and 7, in step 702, a steam inlet stream, an air inlet stream, and power may be provided to the electrolyzer cell columns 101 to generate a hydrogen exhaust (e.g., the hydrogen and steam containing product stream) and an oxygen exhaust (e.g., oxygen enriched air stream). Each of the electrolyzer cell columns 101 includes one or more electrolyzer cell stacks 100.

In step 704, the steam inlet stream provided to the steam recuperator 108 may be heated using the hydrogen exhaust, and the air inlet stream provided to the air recuperator 112 may be heated using the oxygen exhaust.

In step 706, the steam inlet stream output from the steam recuperator 108 to the electrolyzer cell columns 101 may be heated using the outer column heater 350 and/or the base heater 370. In particular, the temperature of the steam may be increased to at least 750° C. In some embodiments, the outer column heater 750 and/or the base heater 770 may increase the temperature of the steam by at least 200° C.

In step 708, the air inlet stream output from the air recuperator 112 and provided to the electrolyzer cell columns 101 may be heated by the inner column heater 360 that is located radially inward of the electrolyzer cell columns 101 and that surrounds the air recuperator 112 and the steam recuperator 108. In particular, the temperature of the air may be increased to at least 750° C. In some embodiments, the inner column heater 360 may increase the temperature of the air by at least 300° C.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. An electrolyzer system, comprising:
electrolyzer cell columns each comprising at least one stack of electrolyzer cells that are configured to receive a steam inlet stream and an air inlet stream, and to generate a hydrogen exhaust stream and an oxygen exhaust stream;
an air recuperator heat exchanger surrounded by the electrolyzer cell columns and configured to heat the air inlet stream using the oxygen exhaust stream;
a steam recuperator heat exchanger surrounded by the electrolyzer cell columns and configured to heat the steam inlet stream using the hydrogen exhaust stream;
an outer column heater located radially outward of the electrolyzer cell columns and configured to radiate heat toward radially outward surfaces of the electrolyzer cell columns; and
an inner column heater located radially inward of the electrolyzer cell columns, surrounding the air recuperator heat exchanger and the steam recuperator heat exchanger, and configured to radiate heat toward radially inward surfaces of the electrolyzer cell columns.

2. The system of claim 1, further comprising:
fuel inlet conduits fluidly connected to the steam recuperator heat exchanger, located below the electrolyzer cell columns, and configured to receive the steam inlet stream output from the steam recuperator heat exchanger; and
a base heater located below the electrolyzer cell columns and configured to heat the fuel inlet conduits.

3. The system of claim 2, further comprising:
steam riser conduits fluidly connecting the fuel inlet conduits to the electrolyzer cell columns, and configured to provide the steam inlet stream output from the fuel inlet conduits to the electrolyzer cell columns, wherein the outer column heater is configured to heat the steam riser conduits;
hydrogen outlet conduits fluidly connected to the steam recuperator heat exchanger, located below the electrolyzer cell columns, and configured to provide the hydrogen exhaust stream to the steam recuperator heat exchanger; and
product riser conduits fluidly connecting the electrolyzer cell columns to the hydrogen outlet conduits and configured to provide the hydrogen exhaust stream from the electrolyzer cell columns to the hydrogen outlet conduits, wherein the base heater is configured to heat the hydrogen outlet conduits.

4. The system of claim 2, wherein the base heater comprises:
a heating element; and
an annular insulation layer comprising ceramic fibers and surrounding the heating element.

5. The system of claim 2, wherein the base heater comprises multiple base heater units, and each base heater unit comprises:
a heating element; and
a prismatic insulation layer comprising ceramic fibers and surrounding the heating element.

6. The system of claim 1, wherein the electrolyzer cells comprise solid oxide electrolyzer cells.

7. The system of claim 1, wherein outer column heater and the inner column heater each comprise:
a heating element; and
a tubular insulation layer comprising ceramic fibers and surrounding the heating element.

8. The system of claim 7, wherein outer column heater and the inner column heater each comprise multiple independently controlled heating elements.

9. The system of claim 1, further comprising an air preheater heat exchanger configured to heat the air inlet stream using the hydrogen exhaust stream.

10. The system of claim 1, wherein the air recuperator heat exchanger is located radially outward of the steam recuperator heat exchanger and surrounds the steam recuperator heat exchanger.

11. The system of claim 1, wherein the steam recuperator heat exchanger is located radially outward of the air recuperator heat exchanger and surrounds the air recuperator heat exchanger.

12. The system of claim 1, further comprising:
a hotbox containing the electrolyzer cell columns, the air recuperator heat exchanger, the steam recuperator heat exchanger, the inner column heater and the outer column heater; and
a central column located in the hotbox and laterally surrounded by the electrolyzer cell columns.

13. A method of operating an electrolyzer system, comprising:
providing electric power, a steam inlet stream and an air inlet stream to electrolyzer cell columns, each electrolyzer cell column comprising at least one electrolyzer cell stack, to generate a hydrogen exhaust stream and an oxygen exhaust stream;
heating the steam inlet stream in a steam recuperator heat exchanger using the hydrogen exhaust stream;
heating the air inlet stream in an air recuperator heat exchanger using the oxygen exhaust stream;
heating the steam inlet stream output from the steam recuperator heat exchanger to the electrolyzer cell columns using an outer column heater that surrounds the electrolyzer cell columns; and
heating the air inlet stream output from the air recuperator heat exchanger to the electrolyzer cell columns using an inner column heater that is located radially inward of the electrolyzer cell columns and that surrounds the air recuperator heat exchanger and the steam recuperator heat exchanger.

14. The method of claim 13, further comprising heating the steam inlet stream output from the steam recuperator heat exchanger using a base heater located below the electrolyzer cell columns.

15. The method of claim 13, wherein:
the heating the steam inlet stream output from the steam recuperator heat exchanger comprises increasing a temperature of the steam inlet stream by at least 200° C.; and
the heating the air inlet stream output from the air recuperator heat exchanger comprises increasing a temperature of the air inlet stream by at least 300° C.

16. The method of claim 13, further comprising independently controlling a temperature of an upper heating element of the outer column heater from a temperature of a lower heating element of the outer column heater.

17. The method of claim 13, further comprising independently controlling a temperature of an upper heating element of the inner column heater from a temperature of a lower heating element of the inner column heater.

18. The method of claim 13, further comprising heating the air inlet stream using the hydrogen exhaust stream in an air preheater heat exchanger.

19. The method of claim 13, wherein the air recuperator heat exchanger is located radially outward of the steam recuperator heat exchanger and surrounds the steam recuperator heat exchanger.

20. The method of claim 13, wherein the steam recuperator heat exchanger is located radially outward of the air recuperator heat exchanger and surrounds the air recuperator heat exchanger.

21. The system of claim 3, further comprising:
multiple electrolyzer cell columns wherein each electrolyzer cell column is comprised of multiple stacks of electrolyzer cells;
steam splitter plates disposed between the stacks in each column, the steam splitter plates configured to provide a portion of the steam from the steam inlet stream to adjacent stacks in the same column and configured to receive a portion of the hydrogen exhaust stream from adjacent stacks in the same column; and
each steam splitter plate is fluidly connected to one of the fluid riser conduits.
